(19) United States
(12) Patent Application Publication
(10) Pub. No.: US 2023/0214910 A1
(43) Pub. Date: Jul. 6, 2023

(54) SCAN AND KNOW SYSTEM AND METHOD

(71) Applicant: Merkle Inc., Columbia, MD (US)

(72) Inventors: Valerie Vacante, Austin, TX (US); Chandrasekar Raju, Chicago, IL (US); Skyler Truax, Charlestown, NH (US); Stefanie Rapoza, Roseville, CA (US)

(21) Appl. No.: 18/147,743

(22) Filed: Dec. 29, 2022

Related U.S. Application Data
(60) Provisional application No. 63/266,277, filed on Dec. 30, 2021.

(51) Int. Cl. G06Q 30/0601; G06K 7/10

(52) U.S. Cl. CPC G06Q 30/0641; G06K 7/1095; G06Q 30/0627

(57) ABSTRACT

A method and computer platform configured to engage a web browser running on a mobile device and displaying an ecommerce website, instruct the web browser to activate a camera module of the mobile device to capture an image using a camera of the mobile device, and update the ecommerce website that is displayed on the web browser to include product information associated with the image.

### CROSS-REFERENCE TO RELATED APPLICATIONS

This non-provisional patent application claims the benefit of, and priority to, U.S. Provisional Pat. Application No. 63/266,277, entitled Scan and Know System and Method, filed on Dec. 30, 2021, which is incorporated by reference in its entirety.

### FIELD OF THE DISCLOSURE

The present disclosure generally relates to shopping, wish lists, and store registries, and more particularly to an application-free digital product learning system and method.

### BACKGROUND

Retailers and their customers desire a simplified means for shopping, learning more about product information (ingredients, how it is made, how it is cared for, storage, pricing, availability,) and the ability to add to a wish list, registry, gift an item in retail environments to simplify the whole shopping process.

Some retailers have employed hardware pricing scanners for price checks, handheld hardware scanners for people to scan items into their registry but these hardware devices are limited to specific tasks, price checking only or adding to registry only and requires a significant investment in hardware displayed or issued by the retailer, for these systems to be used in physical retail environments.

Some retailers have native app experiences that enable item look up items but require manual input of a sku number or UPC code that can often be mistyped. These native application-based systems have been provided for iOS and Android devices; however, the application-based systems typically require customers to have a separate retailer-specific application downloaded to their personal communication devices in order to shop and/or use these application-based systems. Further, customers are somewhat tired of having to download specific applications, as the majority of U.S. consumers download zero applications per month.

If heavy hardware scanners are available in a retailer’s location, the heavy hardware scanners only provide the price of the item, not availability or the ability to add to a wish list or ship to another location. Heavy hardware such as RF scanners generally are held by employees and require a customer to check them out to use in the case of adding items to a wedding / baby registry or only held by retail employees to search for pricing and stock availability. Alternatively, a shopper could manually search the website however there are often typos or other misspellings that could bring up the wrong size, product or sku.

### SUMMARY

Embodiments of the present disclosure may provide a system and method as an application-free, product recognition, selection and payment system and method. The system according to embodiments of the present disclosure may enable retailers to implement and operate a high-quality, amplified customer assistance through product recognition, searching for detailed product information such as price, ingredients, availability, add to wish lists, registry or ship to another location. Customers may select items and add them to their profile wish lists or registry to purchase at a later date or and make purchases in a physical retail environment/storefront without requiring physical checkout having the items delivered to their select location by the retailer. Customers are not required to queue at a cash register in order to make purchases, and customers may shop and make purchases on the retailer’s website without use of an application-based system and have them sent to another location supported by the retailer.

In some aspects, a computer implemented method includes: engaging a web browser running on a mobile device, wherein an ecommerce website is displayed on the web browser during the step of engaging; instructing the web browser to activate a camera module of the mobile device to capture a first image using a camera of the mobile device; and updating the ecommerce website that is displayed on the web browser to include product information associated with the first image.

In some aspects, a computer platform has a processor, memory, and instructions stored on the memory that when executed, cause the processor to: engage a web browser running on a mobile device while an ecommerce website administered by the computer platform is displayed on the web browser; instruct the web browser to activate a camera module of the mobile device to capture a first image using a camera of the mobile device; and update the ecommerce website that is displayed on the web browser to include a product information associated with the first image.

Other technical features may be readily apparent to one skilled in the art from the following figures, descriptions and claims.

### BRIEF DESCRIPTION OF THE DRAWINGS

For a more complete understanding of this disclosure, reference is now made to the following description, taken in conjunction with the accompanying drawings, in which:

FIG. 1 illustrates a process flowchart for a computer system, and functionality for components of the computer system that is applicable to steps of the disclosed method.

FIG. 2 illustrates a schematic diagram of the mobile device and computer platform, and interactions of the software executed in the respective devices.

FIGS. 3A to 3C illustrate a series of screenshots that are displayed on the ecommerce website administered by the computer platform disclosed herein, to a mobile device.

FIG. 4 illustrates aspects and features of the disclosure, and depicts another screenshot of production information displayed on the mobile device for a cosmetic product.

FIG. 5 illustrates questions and answers about the computer system, computer platform, and method.

### DETAILED DESCRIPTION

Embodiments of the present disclosure described herein may provide an application free digital shopping and payment system and method, which may be referred to herein as the Scan and Know System and Method. Embodiments of the present disclosure are a turnkey digital product that may enable retailers to implement and operate high-quality, amplified customer assistance through product recognition, searching for detailed product information such as price, ingredients, availability, add to wish lists, registry or ship to another location.

Customers may shop, searching for detailed product information such as price, ingredients, availability, add to wish lists, registry or ship to another location through amplified assistance and product recognition. When referencing that shopping and making purchases without requiring checkout, this may mean that customers are not required to queue at a cash register in order to make purchases, and customers may shop and make purchases without use of an application-based system.

As described herein, the embodiments of the present disclosure may be integrated into an existing website of a retailer, thereby providing an application-free solution. Retailers are not required to use RF scanners, heavy hardware price check scanners beacons, and/or tagging system needs to be employed within the physical retail environment for operation of the system and method. Use of the system and method according to embodiments of the present disclosure may provide opportunities for retailers to enhance the customer experience, which may increase sales and loyalty.

The Scan and Know System and Method include a computer system, a computer platform, and a method. Aspects of the computer system, computer platform, and method disclosed herein provide an application-free web browser-based product display via an existing website of a retailer that does not require a custom app, but rather uses a customer’s mobile device as an extension of a Scan and Know computer platform. A customer using a customer mobile device can access a website for a retailer that is hosted by a computer platform via a web browser running on the mobile device. The customer can peruse products physically in the store, and if an item is found the customer is interested in, the customer can give permission for the computer platform to engage a web browser and instruct the web browser to activate a camera module of the mobile device to capture an image (e.g., the barcode of the product or item) using a camera of the mobile device. The camera is controlled temporarily as an additional component of the computer platform to capture the image. This control can be performed during product identification. The product can be added to a wish list, added to a registry, or shipped to a mailing address. Payment for the item can be processed as described herein.

Aspects of the computer system, computer platform, and method disclosed herein provide an application-free web browser-based product information display that does not require a custom app, but rather uses a customer’s mobile device as an extension of a computer platform. A customer using a mobile device can access a website for a retailer that is hosted by a computer platform via a web browser running on the mobile device. The customer can peruse products physically in the store, and if an item is found the customer is interested in, the customer can give permission for the computer platform to engage a web browser and instruct the web browser to activate a camera module of the mobile device to capture an image (e.g., the barcode of the product or item) using a camera of the mobile device. The camera is controlled temporarily as an additional component of the computer platform to capture the image. This control can be performed during product identification in order to display information about the product to the mobile device via the retailer website. The product can be added to a wish list, added to a registry, or shipped to a mailing address. Payment for the item can be processed as described herein.

The figures are discussed with respect to functionality of components of the computer system such as the computer platform 100; however, it is to be understood that the functionality applies to the embodiments of the disclosed method.

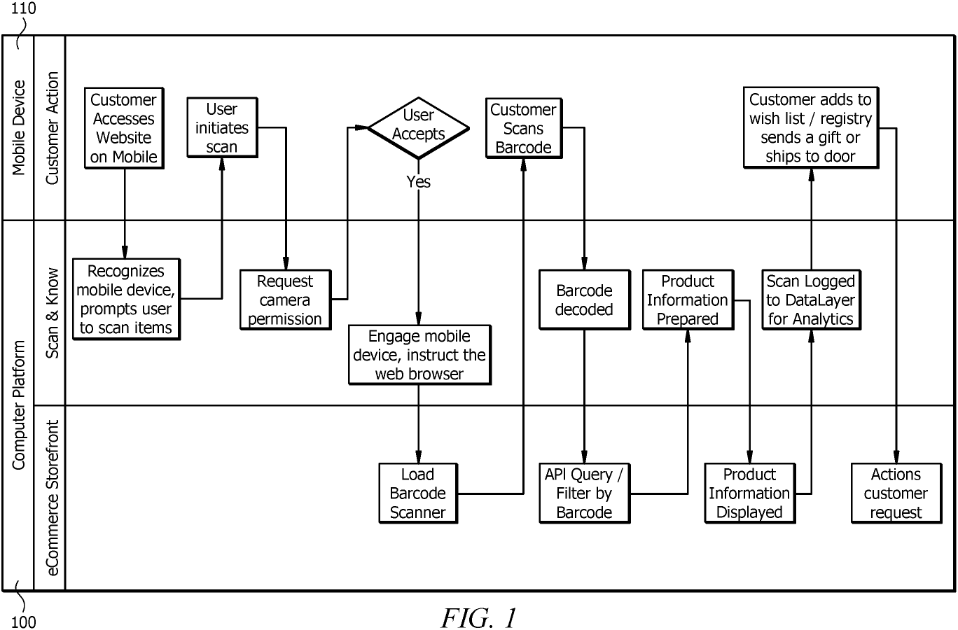

Referring to FIG. 1, the Scan and Know computer system can include a computer platform 100 and at least one mobile device 110. The computer platform 100 can include a database; alternatively, the database can be separate from the computer platform 100. In embodiments, the computer system can include an image processor. In some embodiments, the image processor can be embodied as a software module running on the computer platform 100; alternatively, in other embodiments, the image processor can be embodied as a third-party computer having software running thereon that performs the functions for the image processor disclosed herein.

The components of the computer system can be linked or networked with at least one other component: the at least one mobile device can be networked with the computer platform, the database can be networked with the computer platform, and the image processor can be part of the computer platform or networked with the computer platform. Each of the components of the computer system can be embodied with computer equipment such as one or more processors, memory, networking cards or interfaces, and other equipment for processing data.

Regarding network communication technology, the computer platform can be networked with the other components of the computer system via any wired internet connection, wireless connection, local area network (LAN), wired intranet connection, wireless intranet connection, or combinations thereof.

The computer platform can include one or more processors, memory, networking cards or interfaces, and other equipment for performing the method disclosed that does not require an additional application. The computer platform 100 can include multiple computers, located in a brick-and-mortar location, local to the administrator of the computer platform 100, in the cloud, or a combination thereof. The computer platform 100 can be configured to communicate simultaneously with multiple mobile devices 110 and the database.

Referring still to FIG. 1, the computer platform 100 can be configured to receive an input or detect that the mobile device 110 is accessing the ecommerce website (ecommerce storefront) administered by the computer platform 100. The computer platform 100 can display the website on the mobile device 110 via the web browser of the mobile device 110. The customer can access the ecommerce website by, for example, scanning a QR code, entering in the website URL into a web browser, selecting a link via email or search engine or text message, or combinations thereof.

The computer platform 100 can be configured to prompt the mobile device 110 to scan items via the ecommerce website that is displayed on the mobile device 110. The user can initiate the scan via the mobile device 110, and the computer platform 100 can receive a message that the user requests to initiate a scan from the mobile device 110. The computer platform 100 can instruct the ecommerce website to ask permission to use the camera of the mobile device 110 to make the scan. The computer platform 100 can then receive a message of permission grant or acceptance to use the camera on the mobile device 110.

After receiving the message of permission grant or acceptance, the computer platform 100 can be configured to engage the web browser of the mobile device 110. Moreover, particularly, the computer platform 100 can engage a script of web browser (e.g., JavaScript C#, Python, HTML, CSS, SQL, or another coding language) of the mobile device 110. Prior to this step 204, the computer platform 100 displayed the ecommerce website on the web browser running on the mobile device 110.

The computer platform 100 can be configured to display the website on the web browser in a format that is not location specific.

In embodiments, engaging the web browser of the mobile device 110 can include interacting with a script and using the script to temporarily take over at least a portion of the processing bandwidth of the mobile device 110 in order to obtain a first image (e.g., a barcode of a product) via a camera module of the mobile device 110.

In embodiments, prior to engaging the web browser, the computer platform 100 can receive permission to engage the web browser by customer input at the mobile device 110. For example, the website can include a “Scan Item” button, and the customer can tap the “Scan Item” button, the input can be received by the computer platform 100 as an indication that the customer has given the computer platform 100 permission to engage the script on the web browser running on the mobile device 110 for the limited purpose of scanning the product or item (e.g., scanning the barcode).

The computer platform 100 is configured to instruct the web browser to activate a camera module of the mobile device 110 to capture a first image using a camera of the mobile device 110. The computer platform 100 can interact with the script of the web browser such that the script is instructed to activate the camera module of the mobile device 110. Once the mobile device’s 110 camera module is activated, the camera module can cause the camera to take a photo (e.g., the first image) of a product, and in particular of the barcode of the product.

The computer platform 100, in tandem with the temporary control of the camera of the mobile device 110 via the use of script on the web browser of the mobile device 110, can function as an image scanner (e.g., a barcode scanner). When the camera module is activated, the camera module and camera of the mobile device 110 act as an extension of the computer platform 100 because the computer platform 100 has fractional and temporary control over the mobile device 110. These steps enable the application-free web browser-based product learning because engaging the mobile device 110 to obtain the image links the physical store products with online product learning capabilities on the ecommerce website.

In embodiments, the computer platform 100 can be configured to disengage, or cause the web browser to disengage, from the camera module of the mobile device 110 after the first image is obtained.

In embodiments, the computer platform 100 can send the first image, or cause the web browser (e.g., the script of the web browser) to send the first image, to an image processor. The image processor can be a module contained within the computer platform 100, such as a plugin in the software of the computer platform 100 that is able to read and identify the barcodes for the products. Alternatively, the image processor can be a third-party software module contained on computer equipment that is networked to the computer platform 100 and functions as an image processing service. Examples of commercially available third-party software modules are SCANDIT or ZEBRA. If there is a problem with the image received, such as blurriness, angle, or incomplete barcode, the image processor can return an error message to the computer platform 100, and the computer platform 100 can notify the customer via the ecommerce website on the web browser.

The image processor is configured to determine a product identifier associated with the image (e.g., a product identifier associated with the barcode). The product identifier can be an identifier for the product, including the name, a photo of the product, or other information that identifies the product associated with the image. In these embodiments, the computer platform 100 can also receive the product identifier from the image processor.

After displaying the product information on the mobile device 110 via the ecommerce website, the computer platform 100 can be configured to log the scanned information (e.g., barcode or barcode information) to a data layer of the computer platform 100.

After displaying the product information on the mobile device 110 via the ecommerce website, the computer platform 100 can be configured to instruct the ecommerce website to display options on the mobile device for adding the product to a wish list, adding the product to registry, or shipping the product to a mailing address.

The computer platform 100 can be configured to save the product to the wish list associated with the mobile device 110, save the product to a registry identified by the mobile device 110 via the ecommerce website, or provide an online payment (checkout) sequence.

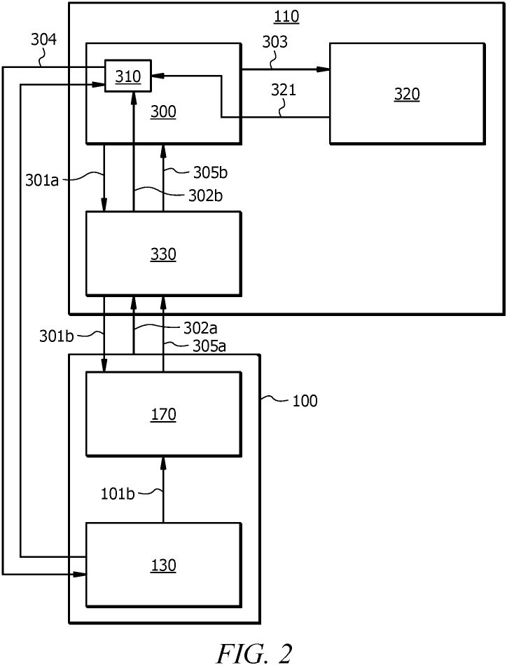

FIG. 2 illustrates a schematic diagram of the mobile device 110 and computer platform 100, and interactions of the software executed in the respective devices.

The mobile device 110 has a web browser 300 running thereon, and the web browser 300 contain script 310, among other scripts and subroutines, plugins, etc. The mobile device 110 also has a camera module 320 contained thereon. The camera module 320 may or may not be running continuously. For example, the camera module 320 may be closed and not running until the script 310 on the web browser 300 engages the camera module 320. The web browser 300 can also contain a translation layer 330 to translate between the ecommerce website and the script 310 of the web browser 300.

The computer platform 100 can include the ecommerce website 170 and the image processor 130. In an alternative embodiment, the image processor 130 is not part of the computer platform 100, and alternative communications are described with respect to this alternative embodiment in arrows 101b, 305a, and 305b.

The web browser 300 can access a website 170, and the web browser 300 can be running a script 310, where the translation layer 330 is configured to allow communication between the computer platform 100 and the mobile device 110.

When a message needs to be sent from the mobile device 110 to the computer platform 100, or vice versa, the message goes through the translation layer 330 to get to the destination. The script 310 can be utilized to instruct camera module 320 on the mobile device 110 to activate the camera of the mobile device 110.

Arrows 301a and 301b represent a permission from the mobile device 110 to the computer platform 100 for the computer platform 100 to engage the script 310 in order to capture the first image described herein.

Arrows 302a and 302b represent the engagement message sent by the computer platform 100 to the script 310 of the web browser 300, where the engagement message engages the script 310 to activate the camera module 320.

Arrow 303 is the activation instruction from the script 310 to the camera module 320, and arrow 321 is the image taken by the camera 160 that is sent from the camera module 320 to the script 310 running on the web browser 300.

Next, arrow 304 is the image that is sent by the script 310 to the image processor 130. In embodiments where the image processor 130 is part of the computer platform 100, the script 310 sends the image to the image processor 130 on the computer platform 100. In those embodiments, the image processor 130 of the computer platform 100 can send the product associated with the image to the web browser 300 via arrow 101a. In alternative embodiments, the image processor 130 send the product association with the image to the computer platform 100, e.g., to the website 170 via arrow 101b. The website 170 is then updated by the computer platform 100 by displaying product information on the website 170 (not in an online shopping cart) which is displayed via arrows 305a and 305b to the web browser 300.

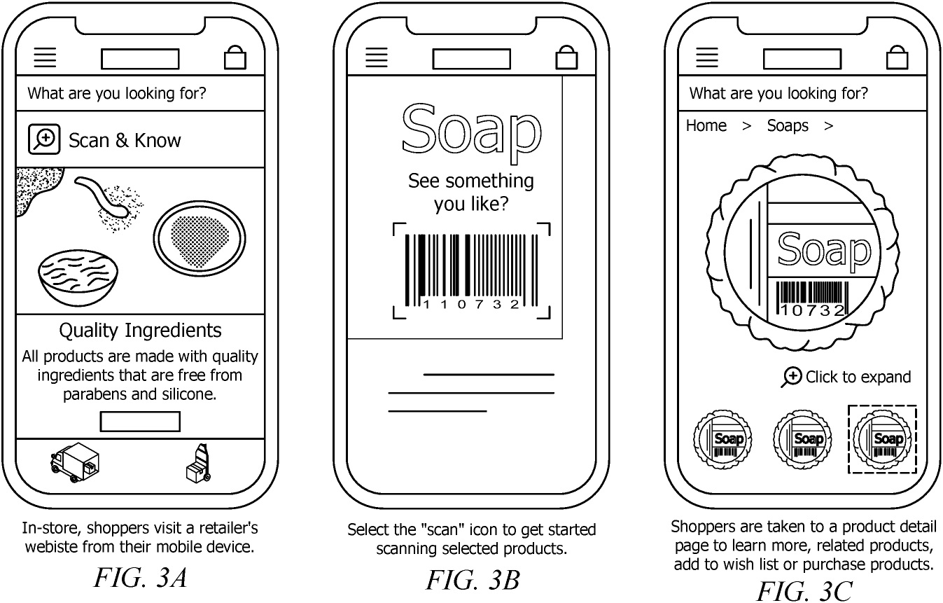

FIGS. 3A to 3C illustrate a series of screenshots that are displayed on the ecommerce website administered by the computer platform disclosed herein, to a mobile device.

FIG. 3A depicts a screenshot of the main page of a retailer’s website where a customer may start using the application-free web browser-based digital product learning method and system for in-store product investigation and learning. As exemplified at the top of the screenshot in FIG. 3A, the customer may be prompted to learn more about products and items that he/she may be interested in by touching the Scan & Know banner.

FIG. 3B depicts a screenshot of what the customer may be directed to when he/she elects Scan & Know. When the customer is ready to begin the learning process, the customer may be presented with a “start scanning” button or screen that leads the customer to start scanning. In embodiments, the customer may be prompted for how to hold the barcode relative to his/her personal communication device, such as by showing a barcode as depicted in FIG. 3B.

FIG. 3C depicts a screenshot of the ecommerce website displaying product information on the mobile device. Any combination of production information can be displayed. In FIG. 3C, the production information includes a photo of the product, additional photos that can be selected.

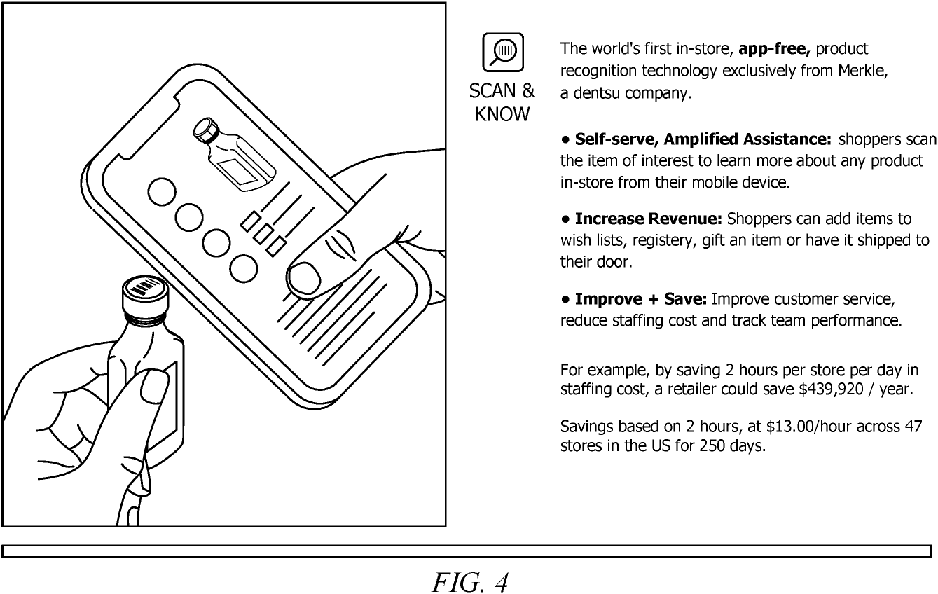

FIG. 4 illustrates aspects and features of the disclosure, and depicts another screenshot of production information displayed on the mobile device for a cosmetic product.

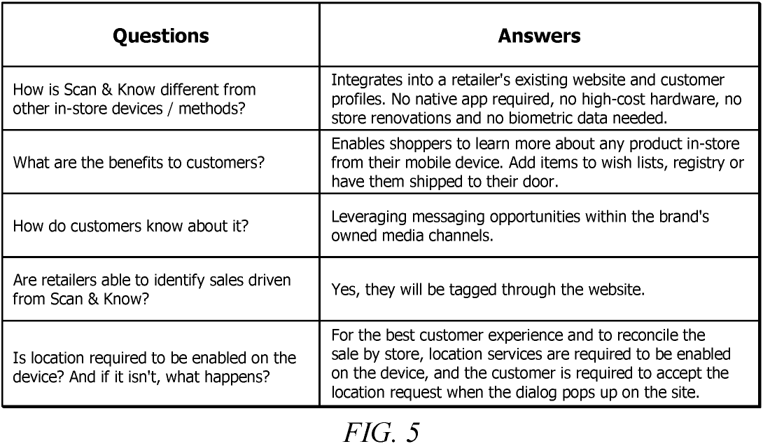

FIG. 5 illustrates questions and answers about the computer system, computer platform, and method.

### ADDITIONAL DESCRIPTION

Aspect 1. A computer implemented method comprising: engaging a web browser running on a mobile device, wherein an ecommerce website is displayed on the web browser during the engaging; instructing the web browser to activate a camera module of the mobile device to capture a first image using a camera of the mobile device; and updating the ecommerce website that is displayed on the web browser to include product information associated with the first image.

Aspect 2. The method of Aspect 1, wherein the product information is not displayed in an online shopping cart.

Aspect 3. The method of Aspect 1 or 2, further comprising: detecting that the mobile device is accessing the ecommerce website.

Aspect 4. The method of any of Aspects 1 to 3, further comprising: prompting the mobile device to scan items via the ecommerce website that is displayed on the mobile device.

Aspect 5. The method of any of Aspects 1 to 4, further comprising: receiving a request to scan an item from the mobile device.

Aspect 6. The method of any of Aspects 1 to 5, further comprising: instructing the ecommerce website to ask a permission to use the camera of the mobile device to make a scan.

Aspect 7. The method of any of Aspects 1 to 6, further comprising: receiving a message of permission grant or acceptance to use the camera.

Aspect 8. The method of any of Aspects 1 to 7, wherein the ecommerce website that is displayed on the web browser is not location specific.

Aspect 9. The method of any of Aspects 1 to 8, wherein engaging the web browser comprises: engaging or interacting with a script of the web browser running on the mobile device; and temporarily taking over at least a portion of a processing bandwidth of the mobile device in order to obtain a first image via the camera module of the mobile device.

Aspect 10. The method of any of Aspects 1 to 9, further comprising: after obtaining the first image from the mobile device, disengaging the web browser from the camera module of the mobile device.

Aspect 11. A computer platform having a processor, memory, and instructions stored on the memory that when executed, cause the processor to: engage a web browser running on a mobile device while an ecommerce website administered by the computer platform is displayed on the web browser; instruct the web browser to activate a camera module of the mobile device to capture a first image using a camera of the mobile device; and update the ecommerce website that is displayed on the web browser to include a product information associated with the first image.

Aspect 12. The computer platform of Aspect 11, wherein the product information is not displayed in an online shopping cart.

Aspect 13. The computer platform of Aspect 11 or 12, wherein the instructions further cause the processor to: detect that the mobile device is accessing the ecommerce website.

Aspect 14. The computer platform of any of Aspects 11 to 13, wherein the instructions further cause the processor to: prompt the mobile device to scan items via the ecommerce website that is displayed on the mobile device.

Aspect 15. The computer platform of any of Aspects 11 to 14, wherein the instructions further cause the processor to: receive a request to scan an item from the mobile device.

Aspect 16. The computer platform of any of Aspects 11 to 15, wherein the instructions further cause the processor to: instruct the ecommerce website to ask a permission to use the camera of the mobile device to make a scan.

Aspect 17. The computer platform of any of Aspects 11 to 16, wherein the instructions further cause the processor to: receive a message of permission grant or acceptance to use the camera.

Aspect 18. The computer platform of any of Aspects 11 to 17, wherein the ecommerce website that is displayed on the web browser is not location specific.

Aspect 19. The computer platform of any of Aspects 11 to 18, wherein engage the web browser comprises: engage or interact with a script of the web browser running on the mobile device; and temporarily take over at least a portion of a processing bandwidth of the mobile device in order to obtain a first image via the camera module of the mobile device.

Aspect 20. The computer platform of any of Aspects 11 to 19, wherein the instructions further cause the processor to: after obtaining the first image from the mobile device, disengage the web browser from the camera module of the mobile device.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A computer implemented method comprising:
engaging a web browser running on a mobile device, wherein an ecommerce website is displayed on the web browser during the engaging;
instructing the web browser to activate a camera module of the mobile device to capture a first image using a camera of the mobile device; and
updating the ecommerce website that is displayed on the web browser to include product information associated with the first image.

2. The method of claim 1, wherein the product information is not displayed in an online shopping cart.

3. The method of claim 1, further comprising:
detecting that the mobile device is accessing the ecommerce website.

4. The method of claim 3, further comprising:
prompting the mobile device to scan items via the ecommerce website that is displayed on the mobile device.

5. The method of claim 4, further comprising:
receiving a request to scan an item from the mobile device.

6. The method of claim 5, further comprising:
instructing the ecommerce website to ask a permission to use the camera of the mobile device to make a scan.

7. The method of claim 6, further comprising:
receiving a message of permission grant or acceptance to use the camera.

8. The method of claim 1, wherein the ecommerce website that is displayed on the web browser is not location specific.

9. The method of claim 1, wherein engaging the web browser comprises:
engaging or interacting with a script of the web browser running on the mobile device; and
temporarily taking over at least a portion of a processing bandwidth of the mobile device in order to obtain a first image via the camera module of the mobile device.

10. The method of claim 9, further comprising:
after obtaining the first image from the mobile device, disengaging the web browser from the camera module of the mobile device.

11. A computer platform having a processor, memory, and instructions stored on the memory that when executed, cause the processor to:
engage a web browser running on a mobile device while an ecommerce website administered by the computer platform is displayed on the web browser;
instruct the web browser to activate a camera module of the mobile device to capture a first image using a camera of the mobile device; and
update the ecommerce website that is displayed on the web browser to include a product information associated with the first image.

12. The computer platform of claim 11, wherein the product information is not displayed in an online shopping cart.

13. The computer platform of claim 11, wherein the instructions further cause the processor to:
detect that the mobile device is accessing the ecommerce website.

14. The computer platform of claim 13, wherein the instructions further cause the processor to:
prompt the mobile device to scan items via the ecommerce website that is displayed on the mobile device.

15. The computer platform of claim 14, wherein the instructions further cause the processor to:
receive a request to scan an item from the mobile device.

16. The computer platform of claim 15, wherein the instructions further cause the processor to:
instruct the ecommerce website to ask a permission to use the camera of the mobile device to make a scan.

17. The computer platform of claim 16, wherein the instructions further cause the processor to:
receive a message of permission grant or acceptance to use the camera.

18. The computer platform of claim 11, wherein the ecommerce website that is displayed on the web browser is not location specific.

19. The computer platform of claim 11, wherein engage the web browser comprises:
engage or interact with a script of the web browser running on the mobile device; and
temporarily take over at least a portion of a processing bandwidth of the mobile device in order to obtain a first image via the camera module of the mobile device.

20. The computer platform of claim 19, wherein the instructions further cause the processor to:
after obtaining the first image from the mobile device, disengage the web browser from the camera module of the mobile device.
